(19) United States
(12) Patent Application Publication
(10) Pub. No.: US 2015/0000274 A1
(43) Pub. Date: Jan. 1, 2015

(54) WASTE HEAT RECOVERY SYSTEM INCLUDING CONNECTION TO A VEHICLE AIR CONDITIONING SYSTEM

(71) Applicant: Cummins Inc., Columbus, IN (US)

(72) Inventors: Timothy C. ERNST, Columbus, IN (US); Christopher R. NELSON, Columbus, IN (US); James A. ZIGAN, Versailles, IN (US); Tony ROUSSEAUO, Columbus, IN (US)

(21) Appl. No.: 13/931,357

(22) Filed: Jun. 28, 2013

(51) Int. Cl. F02G 5/02

(52) U.S. Cl. CPC F02G 5/02
USPC 60/616

(57) ABSTRACT

The disclosure describes a Rankine cycle waste heat recovery (WHR) system that provides cooling to an air conditioning condenser and may use waste heat from the air conditioning condenser to raise the temperature of a working fluid of the WHR system. The Rankine cycle WHR system also converts waste heat from an internal combustion engine in which the WHR system is positioned. Thus, the Rankine cycle waste heat recovery system serves to provide cooling to an air conditioning system of an internal combustion system while serving to convert waste heat into useful energy.

### TECHNICAL FIELD

This disclosure relates to waste heat recovery (WHR) systems and their connection to waste heat sources in a vehicle.

### BACKGROUND

Recovering waste heat is one way to meet legislated and competitive fuel efficiency requirements for internal combustion engines. A WHR system to recover heat energy generated by an internal combustion engine that would otherwise be lost through cooling and heat rejection is one way to improve engine efficiency.

### SUMMARY

This disclosure provides an internal combustion engine comprising a Rankine cycle waste heat recovery system and an air conditioning system. The Rankine cycle waste heat recovery system includes a working fluid circuit, and a fluid containment and cooling system including a condenser and a pump. The air conditioning system includes an air conditioning circuit, and an air conditioning condenser, which is positioned along the working fluid circuit downstream from the pump and upstream from the fluid containment and cooling system condenser.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a schematic of an internal combustion engine incorporating a WHR system in accordance with a first exemplary embodiment of the present disclosure.

FIG. 2 is a schematic of an internal combustion engine incorporating a WHR system in accordance with a second exemplary embodiment of the present disclosure.

### DETAILED DESCRIPTION

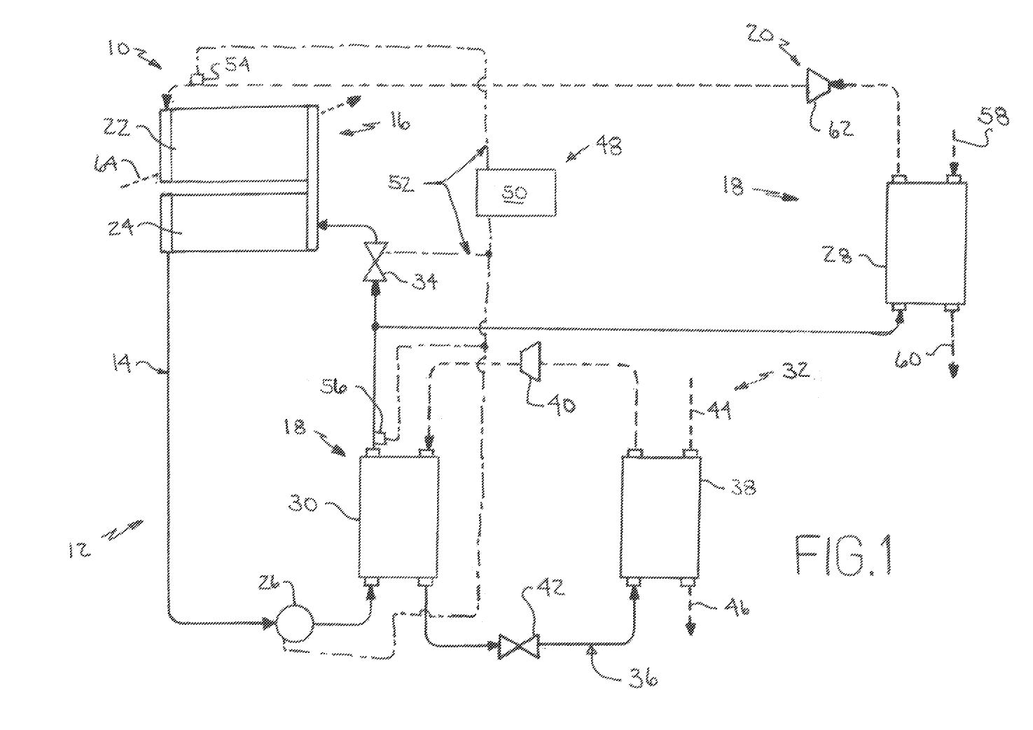

A Rankine cycle waste heat recovery (WHR) system can convert a portion of heat energy in an internal combustion engine, such as exhaust gas heat energy and other engine heat sources (e.g., engine oil, exhaust gas, charge gas, water jackets), which would otherwise be wasted, into energy that can perform useful work. In converting the captured heat energy into useful work, a portion of the waste heat energy can be recovered to enhance an engine's efficiency. While such systems have been refined and improved, there remain opportunities to expand the scope of WHR systems and the amount of heat they are able to recover. One such system uses the waste heat of an air conditioning system and is included in an internal combustion engine shown in FIG. 1 and generally indicated at 10.

Internal combustion engine 10 includes a Rankine cycle WHR system 12 in accordance with a first exemplary embodiment of the present disclosure. WHR system 12 includes a working fluid circuit 14, along which are located a fluid containment and cooling system (FCCS) 16, a heat exchange portion 18, and an energy capture system 20.

FCCS 16 may include a variety of devices for containing and cooling a working fluid. For example, FCCS 16 may include a condenser 22 for changing the phase of a vaporized working fluid to a liquid. Condenser 22 may have a sub-cooling portion or a sub-cooler 24 located along circuit 14 downstream from condenser 22. FCCS 16 may include other elements, for example, a receiver, a pump, one or more valves, and/or other elements (not shown) to transfer fluid between the various components of FCCS 16.

A working fluid or feed pump 26 is located along working fluid circuit 14 downstream from FCCS 16. Feed pump 26 pulls liquid working fluid from FCCS 16 and pumps the liquid working fluid downstream along working fluid circuit 14 toward heat exchange portion 18. Heat exchange portion 18 includes at least one heat exchanger 28. Heat exchanger 28 may be a plurality of heat exchangers, such as an EGR heat exchanger, a pre-charge air cooler heat exchanger, heat exchanger, an engine heat exchanger, an exhaust heat exchanger, a recuperator, or other heat exchangers that may benefit from an exchange of heat with the relatively cool liquid working fluid coming from FCCS 16. These heat exchangers may be in series, parallel, or a combination of series and parallel. In the exemplary embodiment of FIG. 1, heat exchange portion 18 includes an air conditioning condenser 30, which is part of a vehicle or cabin air conditioning system 32. A first control valve 34 may be positioned between air conditioning condenser 30 and FCCS 16 and functions to direct working fluid to FCCS 16 during circumstances where the temperature of heat exchanger(s) 28 is too low for proper functioning of engine 10.

Energy capture system 20 is positioned between heat exchange portion 18 and FCCS 16, downstream from heat exchange portion 18. Energy capture system 20 may include a conversion device 62 that powers an auxiliary system.

Vehicle air conditioning system 32 includes an air conditioning circuit 36, along which are positioned an air conditioning evaporator 38, air conditioning condenser 30, a refrigerant vapor compressor 40 positioned downstream from air conditioning evaporator 30, and a thermostatic expansion valve 42 positioned upstream from air conditioning evaporator. Vehicle air conditioning system 32 operates by evaporating an air conditioning working fluid in air conditioning evaporator 38, providing a cooling effect on cabin air 44 flowing into air conditioning evaporator 38, which departs air conditioning evaporator 38 as cooled cabin air 46. The evaporated air conditioning working fluid, which is at an elevated temperature, flows downstream to refrigerant vapor compressor 40, which increases the pressure of the air conditioning working fluid, partially changing the air conditioning working fluid from a vapor to a liquid. The relatively warm air conditioning working fluid flows into air conditioning condenser 30, which transfers heat to the working fluid of WHR 12, described further hereinbelow, cooling the air conditioning working fluid further, completing the conversion of air conditioning working fluid from a vapor to a fluid.

WHR system 12 also includes a control system 48. Control system 48 may include a control module 50, a wire harness 52, a first temperature sensor 54 positioned along working fluid circuit 14 upstream from FCCS 16 and downstream from energy capture system 20, and a second temperature sensor 56 positioned downstream from air conditioning condenser 30 and upstream from FCCS 16.

Control module 50 may be an electronic control unit or electronic control module (ECM) that monitors the performance of WHR system 12 or may monitor other conditions of engine 10 or an associated vehicle in which WHR system 12 may be located. Control module 50 may be a single processor, a distributed processor, an electronic equivalent of a processor, or any combination of the aforementioned elements, as well as software, electronic storage, fixed lookup tables and the like. Control module 50 may connect to certain components of engine 10 by wire harness 52, though such connection may be by other means, including a wireless system. For example, control module 50 may connect to feed pump 26. Control module 50 may include a digital or analog circuit.

WHR system 10 works as follows. FCCS 16 contains a supply of liquid working fluid. Feed pump 26 pulls the liquid working fluid from FCCS 16 and forces the liquid working fluid through working fluid circuit 14. Control system 48 may send control signals to feed pump 26 to vary the speed of feed pump 26, which changes the rate at which heat is transferred to the working fluid by various heat exchangers, described further hereinbelow. The liquid working fluid travels downstream from feed pump 26 into air conditioning condenser 30, cooling the air conditioning working fluid of air conditioning circuit 36. If air conditioning system 32 is operating, heat is transferred from air conditioning circuit 36 to working fluid circuit 14 in air conditioning condenser 30. Downstream from air conditioning condenser 30, the liquid working fluid may flow through first control valve 34 back into FCCS 16, or the liquid working fluid may flow into heat exchanger(s) 28. Control module 50 receives a temperature signal from first temperature sensor 54. If the temperature of the working fluid is too low, indicating that internal combustion engine 10 needs to become hotter in order to function properly, then control module 50 may open first control valve 34 to permit some or all working fluid to return directly to FCCS 16. If the temperature of heat exchanger(s) 28 is sufficient to convert liquid working fluid to gaseous working fluid, which control module 50 may determine from a temperature signal provided by second temperature sensor 56 in combination with the temperature signal from first temperature sensor 54, first control valve 34 is closed, either partially or completely, considering the temperature of heat exchanger(s) 28. Thus, air conditioning condenser 30 serves to preheat or raise the temperature of the liquid working fluid, and heat exchanger(s) 28 serve to vaporize the liquid working fluid. Heat exchanger(s) 28 receive a waste heat source 58 and transfer the heat from waste heat source 58 to the working fluid to convert the working fluid to a vapor. The flow of waste heat is cooled and returned to the source system as a reduced temperature flow 60, beneficially cooling the system that provided waste heat source 58.

The vaporized working fluid moves downstream to energy capture system 20. As the vaporized working fluid flows through conversion device or Rankine cycle expander 62 of energy capture system 20, the vaporized working fluid expands and cools, transferring energy to conversion device 62. The energy transferred to conversion device 62 may now be used to drive or operate an auxiliary system (not shown) of a vehicle in which WHR system 12 is located. The auxiliary system can channel mechanical energy into the driveline (not shown) of engine 10 or can generate electrical energy to power electrical devices or for storage in one or more batteries. If the auxiliary system is an electrical generator, the power could power a driveline motor generator (not shown) by way of power electronics (not shown) to help drive a vehicle (not shown) in which engine 10 is mounted. The vaporized working fluid flows downstream to FCCS 16, where the vaporized working fluid is condensed, cooled by an air flow 64, and stored to be available to travel through working fluid circuit 14 again.

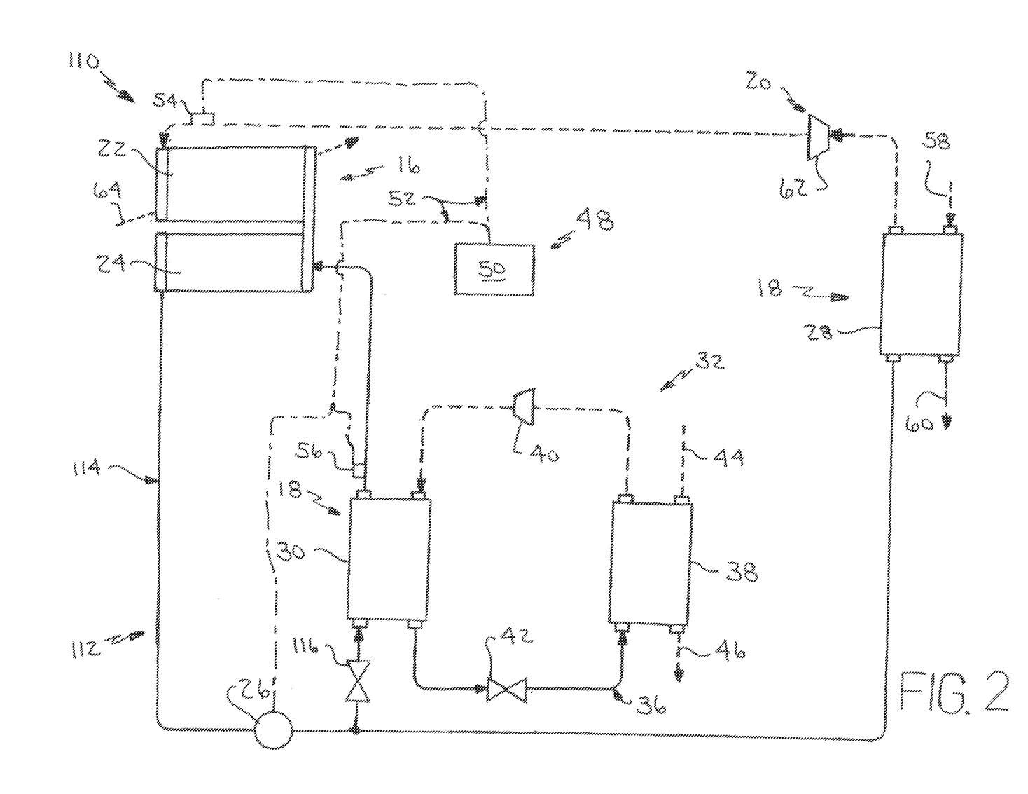

The working fluid described in the configuration shown in FIG. 1 and in subsequent FIG. 2 can be a non-organic or an organic working fluid. Some examples of working fluid are Genetron® R-245fa from Honeywell, Therminol®, Dowtherm J™ from Dow Chemical Co., Fluorinol® from American Nickeloid, toluene, dodecane, isododecane, methylundecane, neopentane, octane, water/methanol mixtures, and steam.

Turning now to FIG. 2, an internal combustion engine 110 includes a Rankine cycle WHR system 112 in accordance with a second exemplary embodiment of the present disclosure. WHR system 112 beneficially cools air conditioning condenser 30 of air conditioning system 32, thus using the cooling capacity of WHR system 112 to providing cooling for the working fluid of air conditioning system 32 in addition to making use of waste heat to drive an energy capture portion 20. WHR system 112 includes a working fluid circuit 114, along which are located fluid containment and cooling system (FCCS) 16, heat exchange portion 18, and energy capture system 20. Elements of WHR system 112 that are similar to elements of WHR system 12 have the same item number as WHR system 12 and are described in this embodiment only for the sake of clarity.

Working fluid or feed pump 26 is located along working fluid circuit 114 downstream from FCCS 16. Feed pump 26 pulls liquid working fluid from FCCS 16 and pumps the liquid working fluid downstream along working fluid circuit 114 toward heat exchange portion 18. A first control valve 116 is positioned between feed pump 26 and air conditioning condenser 32 and functions to direct working fluid through air conditioning condenser 30 to FCCS 16 during circumstances where the temperature of heat exchanger(s) 28 is too low for proper functioning of engine 10 or in circumstances where air conditioning condenser 30 requires cooling.

WHR system 110 works as follows. FCCS 16 contains a supply of liquid working fluid. Feed pump 26 pulls the liquid working fluid from FCCS 16 and forces the liquid working fluid through working fluid circuit 114. Control system 48 may send control signals to feed pump 26 to vary the speed of feed pump 26, which changes the rate at which heat is transferred to the working fluid by various heat exchangers, described further hereinbelow. The liquid working fluid travels downstream from feed pump 26 into heat exchanger(s) 28 or into air conditioning condenser 30, depending on whether first control valve 116 is either partially or completely open. If air conditioning system 32 is operating, heat is transferred from air conditioning circuit 36 to working fluid circuit 114 in air conditioning condenser. Downstream from air conditioning condenser 30, the liquid working fluid flows into FCCS 16, where the liquid working fluid is cooled before flowing into feed pump 26. Control module 50 receives a signal from first temperature sensor 54. If the temperature of the working fluid is too low, indicating that internal combustion engine 10 needs to become hotter in order to function properly, then control module 50 may open first control valve 116 to permit some or all working fluid to return directly to FCCS 16. If the temperature of heat exchanger(s) 28 is sufficient to convert liquid working fluid to gaseous working fluid, which control module 50 may determine from a temperature signal provided by first temperature sensor 54, first control valve 34 is closed, either partially or completely, considering the temperature of heat exchanger(s) 28 and the temperature of air conditioning condenser 30. Heat exchanger(s) 28 receive waste heat source 58 and transfer the heat from waste heat source 58 to the working fluid to convert the working fluid to a vapor. The flow of waste heat is cooled and returned to the source system as a reduced temperature flow 60, beneficially cooling the system that provided waste heat source 58. From heat exchanger(s) 28, the vaporized working fluid moves downstream to energy capture system 20 and working fluid circuit operates as described in the first embodiment.

One benefit to the hereinabove described embodiments is that air conditioning condenser 30 is now part of the WHR system rather than being part of the air conditioning cooling package, which reduces restriction of airflow into the engine. Another benefit is that heat rejection in air conditioning condenser 30 affects the WHR system only when it runs rather than affecting cooling air flow all the time. Yet another benefit is that WHR system condenser 22, which may be larger in size to handle the cooling needs of both the air conditioning system and the WHR system, benefits from increased air flow due to the removal of the air conditioner condenser from the ram air stream, since cooling of the air conditioning working fluid is by way of the WHR system only.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

I/we claim:

1. An internal combustion engine, comprising:
a Rankine cycle waste heat recovery system including a working fluid circuit, and a fluid containment and cooling system including a condenser and a pump positioned along the working fluid circuit; and
an air conditioning system including an air conditioning circuit, and an air conditioning condenser positioned along the working fluid circuit downstream from the pump and upstream from the fluid containment and cooling system condenser.
